(19) United States
(12) Patent Application Publication
(10) Pub. No.: US 2026/0024939 A1
(43) Pub. Date: Jan. 22, 2026

(54) CONNECTOR

(71) Applicant: P-TWO INDUSTRIES INC., Taoyuan City (TW)

(72) Inventors: Jeng-Yi You, Taoyuan City (TW); Chih-Wei Huang, Taoyuan City (TW)

(21) Appl. No.: 19/076,676

(22) Filed: Mar. 11, 2025

(30) Foreign Application Priority Data
Jul. 22, 2024 (TW) 113127379

(51) Int. Cl. H01R 13/46; H01R 12/70; H01R 12/71; H01R 13/04; H01R 13/514

(52) U.S. Cl. CPC H01R 13/465; H01R 12/7064; H01R 12/716; H01R 13/04; H01R 13/514

(57) ABSTRACT

A connector is provided. The connector has a housing and a plurality of identification units. The housing has a plurality of housing units, and each housing unit has a hollow body, a key structure and an open end. The key structure is formed on an inner edge of the hollow body, and the open end is formed on a side surface of the hollow body. The hollow body and the open end jointly define a receiving space for connecting a mating connector. The housing units are integrally formed with each other, and the key structures of each housing unit are different from each other. Each identification unit is respectively provided on each housing unit to identify and distinguish each housing unit accordingly.

### CROSS-REFERENCES TO RELATED APPLICATIONS

This application claims the benefit of priority to Taiwanese Patent Application No. 113127379 filed on Jul. 22, 2024, which is hereby incorporated by reference in its entirety.

### BACKGROUND OF THE INVENTION

### Field of the Invention

The present invention relates to a connector, in particular to a connector having an integrated housing easily to identify key positions.

### Descriptions of the Related Art

In order to meet the various functional requirements of different electronic products, traditional connectors have begun to use a combination of multiple modularized connectors. For example, Taiwan utility model patent M599037 reveals an assembly connector that allows more than two assembly connectors to be combined together.

However, this multi-piece assembly design will inevitably increase the width and volume of the connector and will adversely affect the miniaturization of the product. Moreover, the multi-piece assembly design also has problems with assembly tolerances when assembling the housing, which leads to increased assembly time and production costs.

In view of this, the present invention proposes an integrated connector to solve the problems of increased width, volume, assembly tolerances, labor hours and costs of the products designed by multi-piece combination in the prior art.

### SUMMARY OF THE INVENTION

The objective of the present invention is to provide an innovative integrated connector that addresses the issues of traditional multi-piece connectors, such as difficulties in controlling assembly tolerances during assembly, as well as increases in width and volume. This solution helps to reduce subsequent production time and lower manufacturing costs. Additionally, the integrated connector of the present invention features different identification units on the single-piece housing. This allows users to easily and accurately distinguish between different specifications of connectors on the same housing when connecting mating connectors to ensure correct pairing and connection.

To achieve the above objective, the present invention discloses a connector. The connector has a housing and a plurality of identification units. The housing has a plurality of housing units, and each housing unit has a hollow body, a key structure and an open end. The key structure is formed on an inner edge of the hollow body, and the open end is formed on a side surface of the hollow body. The hollow body and the open end jointly define a receiving space for connecting a mating connector. The housing units are integrally formed with each other, and the key structures of each housing unit are different from each other. Each identification unit is respectively provided on each housing unit to identify and distinguish each housing unit accordingly.

In one embodiment of the connector of the present invention, each of the identifications units is a color plate and each of the color plates has a different color for identify and distinguish each of the housing units correspondingly.

In one embodiment of the connector of the present invention, each of the color plates is detachably embedded in each of the housing units.

In one embodiment of the connector of the present invention, each color plate has an embedding section, each hollow body of the housing units has an embedding groove disposed on a top surface of each hollow body, and each embedding section is detachably embedded in each embedding groove so that each of the color plates is individually fixed in each of the housing units.

In one embodiment of the connector of the present invention, each identification unit is a coloring section formed on an end surface of the open end of each hollow body, and each coloring section has a different color to identify and distinguish each of the housing units correspondingly.

In one embodiment of the connector of the present invention, the connector further comprises a plurality of contacts where one end of each contact is embedded in each receiving space from an opposite side of each open end of the hollow body for electrically being connected to contacts of the mating connector.

In one embodiment of the connector of the present invention, the contacts are divided into an upper contact group and a lower contact group. When the contacts are embedded in each of the receiving spaces, the lower contact group is positioned under the upper contact group.

In one embodiment of the connector of the present invention, the connector further comprises a plurality of gaskets, detachably embedded in each housing unit. Each gasket has a plurality of openings for the other opposite end of each contact passing through the openings accordingly.

In one embodiment of the connector of the present invention, the housing is positioned on an external circuit board, and the other opposite end of each of the contacts is electrically connected to the external circuit board after passing through each of the openings.

In one embodiment of the connector of the present invention, the housing further comprises at least positioning pin, disposed on a bottom side of the hollow bodies, passing through the external circuit board to position the housing on the external circuit board.

After referring to the drawings and the embodiments as described in the following, those the ordinary skilled in this art can understand other objectives of the present invention, as well as the technical means and embodiments of the present invention.

### BRIEF DESCRIPTION OF THE DRAWINGS

FIG. 1 is a schematic diagram of a connector in one embodiment of the present invention;

FIG. 2 is a front exploded view of the connector in one embodiment of the present invention;

FIG. 3 is a rear exploded view of the connector in one embodiment of the present invention;

FIG. 4 is a schematic diagram of the housing in one embodiment of the present invention;

FIG. 5 is a schematic diagram of the housing with three housing units in one embodiment of the present invention;

FIG. 6 is a schematic diagram of a connector with three color plates in one embodiment of the present invention;

FIG. 7 is a schematic diagram showing the color plates being detachably embedded in the housing units of the connector in one embodiment of the present invention;

FIG. 8 is a schematic diagram of a connector with different identification units in one embodiment of the present invention; and

FIG. 9 is a rear exploded schematic diagram of the connector in one embodiment of the present invention.

### DETAILED DESCRIPTION OF THE PREFERRED EMBODIMENT

In the following description, the present invention will be explained with reference to various embodiments thereof. These embodiments of the present invention are not intended to limit the present invention to any specific environment, application or particular method for implementations described in these embodiments. Therefore, the description of these embodiments is for illustrative purposes only and is not intended to limit the present invention. It shall be appreciated that, in the following embodiments and the attached drawings, a part of elements not directly related to the present invention may be omitted from the illustration, and dimensional proportions among individual elements and the numbers of each element in the accompanying drawings are provided only for ease of understanding but not to limit the present invention.

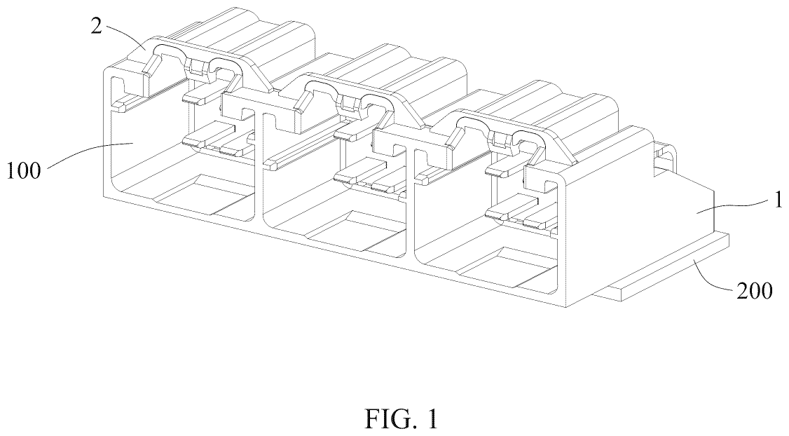

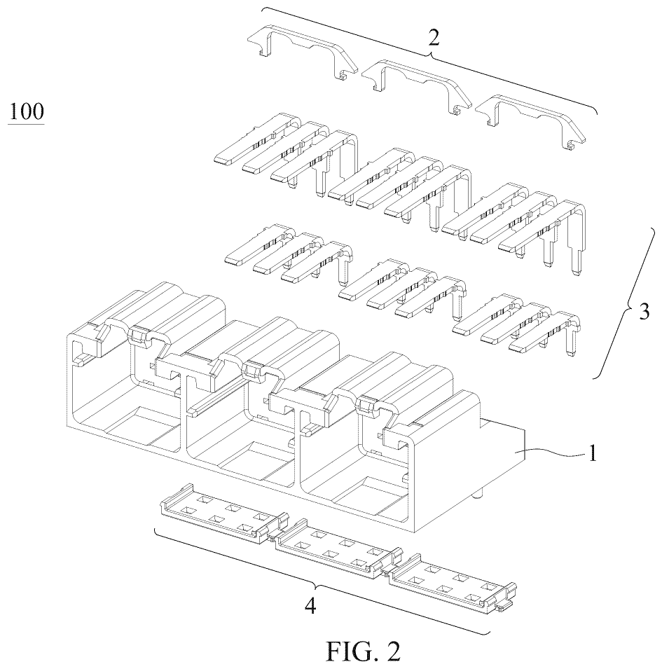

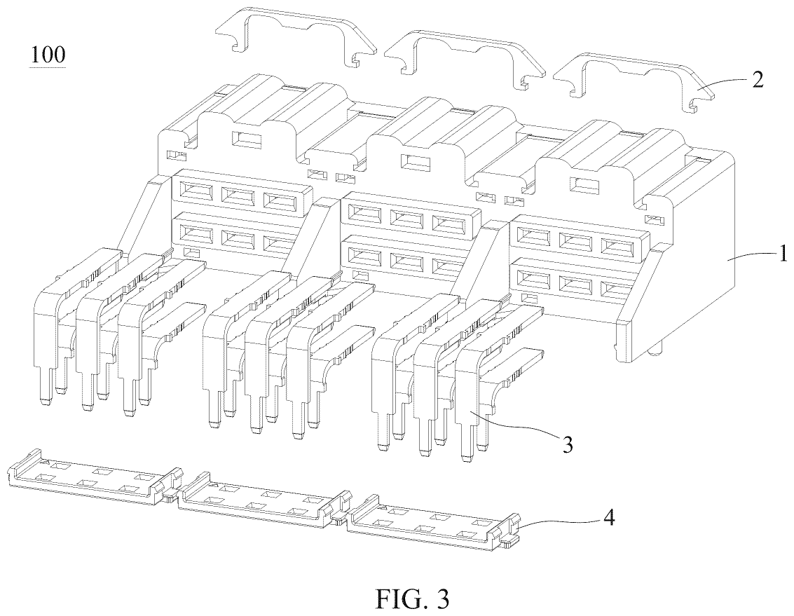

Please refer to FIG. 1, FIG. 2, and FIG. 3. FIG. 1 shows a schematic diagram of the connector 100 in one embodiment of the present invention. FIG. 2 and FIG. 3 respectively show a front exploded view and a rear exploded view of the connector 100 in one embodiment of the present invention. The connector 100 of the present invention includes a housing 1, multiple identification units 2, multiple contacts 3, and multiple gaskets 4. In this embodiment, the connector 100 primarily serves as a board-side connector of a wire-to-board connector, where one end is mounted on an external circuit board 200, and the other end is used for connection with a mating connector (not shown).

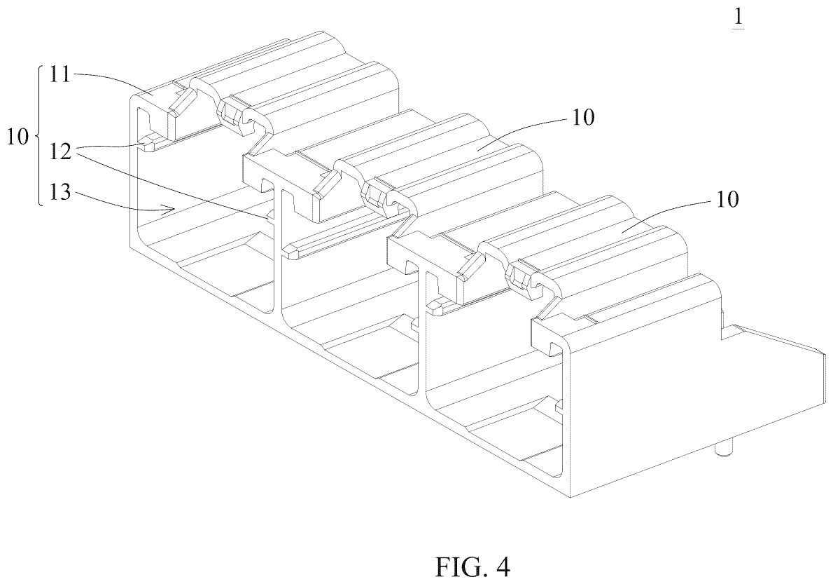

First, the housing 1 is illustrated. Please refer to FIG. 2, FIG. 3, and FIG. 4 together, while FIG. 4 shows a schematic diagram of the housing in one embodiment of the present invention. The housing 1 of the connector 100 in the present invention comprises multiple housing units 10. In the embodiment shown in FIG. 4, the housing 1 of the connector 100 consists of three housing units 10. The three housing units 10 shown in FIG. 4 are only for illustrative purposes and do not limit the present invention. The number of housing units 10 can be increased or decreased depending on actual demands. However, it should be noted that to achieve product miniaturization, all housing units 10 in the housing 1 of the connector 100 are integrally formed. The integrally formed housing in the present invention avoids the issues caused by assembling multi-piece connectors, such as increased width and volume, difficulty in controlling assembly tolerances, as well as increased assembly time and manufacturing costs.

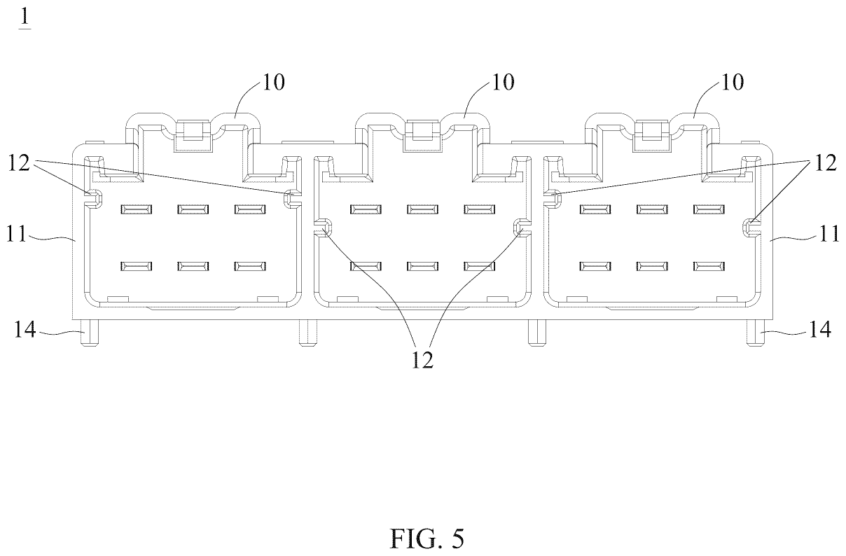

As shown in FIG. 4, each housing unit 10 of the housing 1 in the present invention has a hollow body 11, a key structure 12, and an open end 13. The hollow body 11 can be formed by injection molding, for example, but not limited to, using insulating resin or polymer materials. The open end 13 is formed on one side of the hollow body 11, with the hollow body 11 and open end 13 together defining a receiving space for mating connectors (not shown) to fit along the opening direction. Additionally, the key structure 12 is formed on the inner edge of the hollow body 11. The positions of the key structures 12 in each housing unit 10 differ from each other on the inner edges of the sidewalls for providing identification and pairing for different mating connectors. As shown in FIG. 5, it clearly displays the three housing units 10 forming the housing 1 in one embodiment of the present invention. The key structures 12 of each housing unit 10 differ in height for serving to match different mating connectors. In a preferred embodiment, the housing 1 also has at least one positioning pin 14, disposed on the bottom side of the hollow body 11 of the integrally formed housing units 10. This pin passes through the external circuit board 200 for positioning the housing 1 on the external circuit board 200.

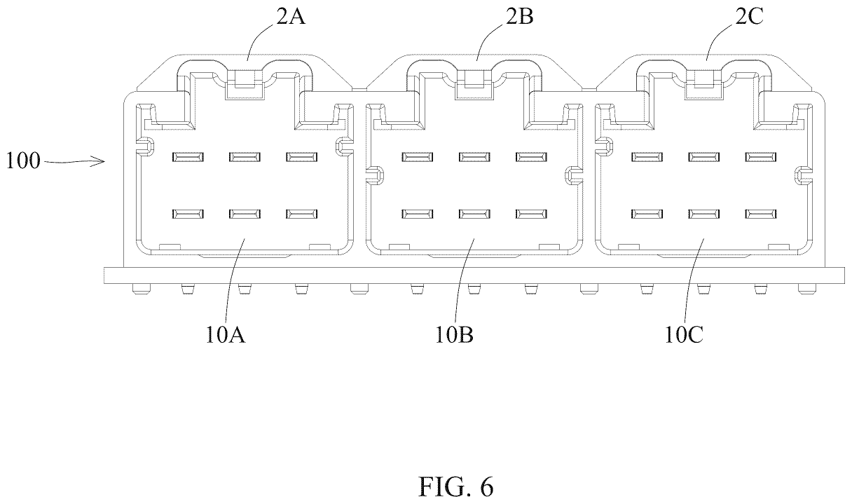

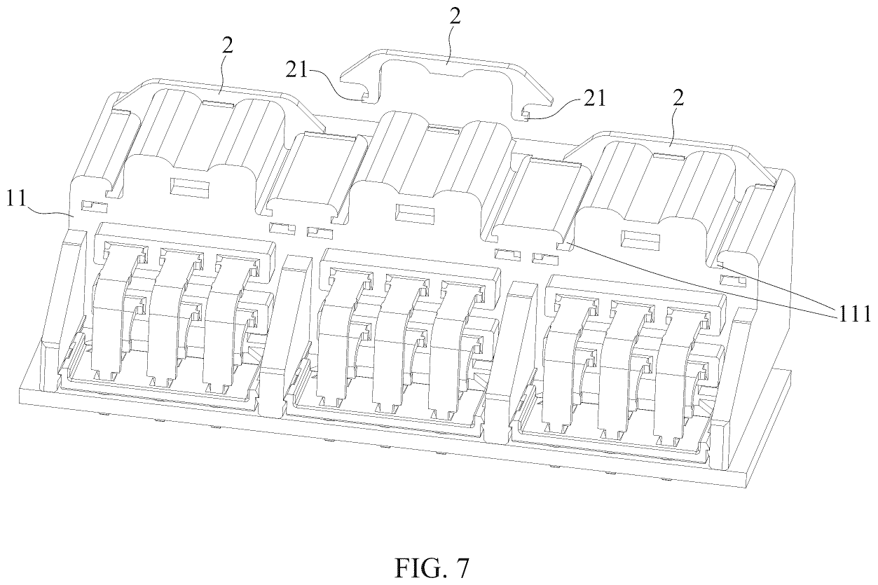

Next, the identification units 2 are illustrated. Please refer to FIG. 1 through FIG. 3, FIG. 6, and FIG. 7. In the illustrated embodiment, the connector 100 has three identification units 2, each disposed on one of the three housing units 10 to correspondingly identify and distinguish them. In this embodiment, the identification units are color plates with different colors attached to distinguish each housing unit. As shown in FIG. 6, for example, the connector 100 in the present invention has three color plates: a gray color plate 2A, a green color plate 2B, and a blue color plate 2C, which are detachably embedded in the first housing unit 10A, the second housing unit 10B, and the third housing unit 10C, respectively. When the mating connectors being connected, users can easily distinguish between different connectors by the different colors of the identification units, and with the corresponding key structures, to achieve proper connection. Please refer to FIG. 7, which shows that the color plates of the connector in the present invention are arcuate thin plates, with each side of the arcuate thin plate having an embedding section 21. On the other hand, each hollow body 11 of the housing units 10 has an embedding groove 111 disposed on the top surface thereof, and the embedding sections 21 of the color plates with different colors can be correspondingly and detachably embedded into each embedding groove 111 for thereby fixing the color plates on the respective housing units 10.

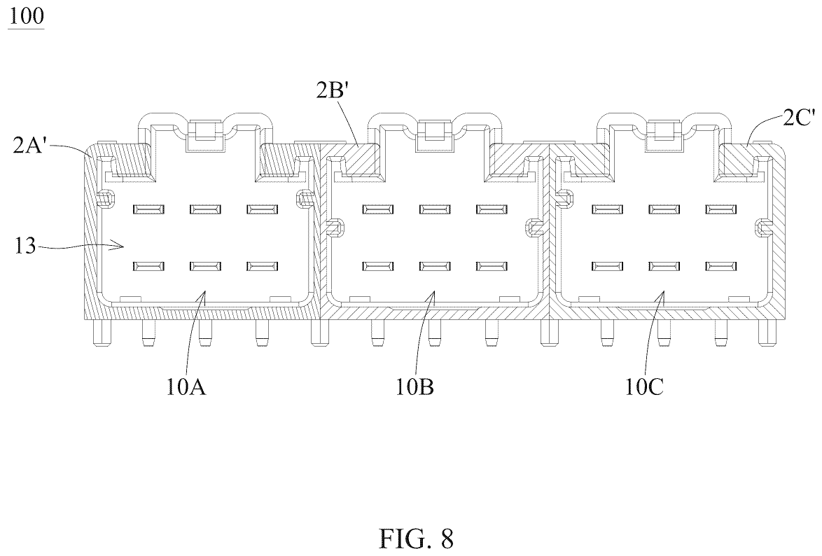

Please refer to FIG. 8, which shows a connector with different identification units in another embodiment of the present invention. In this embodiment, the identification units 2 are coloring sections formed on one end face of the open end 13 of each hollow body 11. Each coloring section is applied using spray printing technology on the end face of the open end 13 with different colors to correspondingly identify and distinguish the housing units 10. As shown in FIG. 8, the connector 100 of the present invention has three different coloring sections at the open end 13: a gray-coloring section 2A′, a green-coloring section 2B′, and a blue-coloring section 2C′ (represented by different shading lines in FIG. 8 to indicate the different colors on each end face), corresponding to the three housing units: the first housing unit 10A, the second housing unit 10B, and the third housing unit 10C. When mating connectors being connected, the different coloring sections make it easy to identify and distinguish the different connectors, and with the different key structures, configured to achieve proper connection.

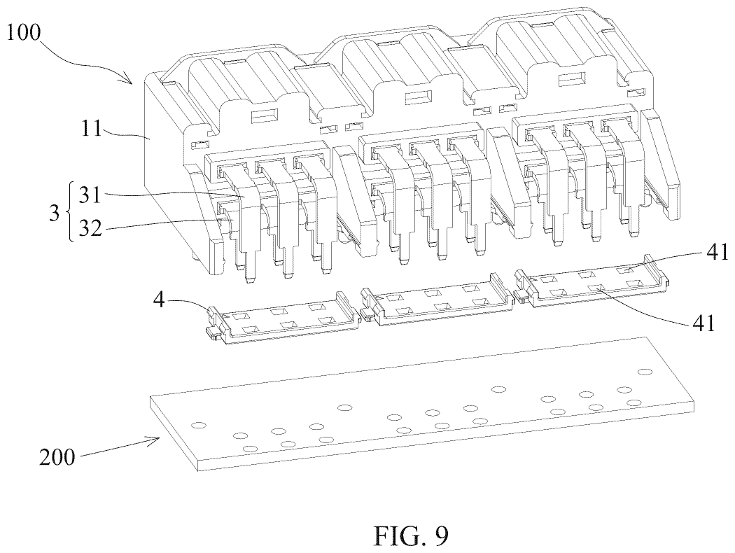

Please refer to FIG. 9, which shows that the connector 100 in one embodiment of the present invention also includes multiple contacts 3. In this embodiment, the contacts 3 can be divided into an upper contact group 31 and a lower contact group 32. When the contacts 3 are embedded into the receiving spaces of the hollow bodies 11, the lower contact group 32 is placed below the upper contact group 31. One end of each contact 3 in the upper contact group 31 and the lower contact group 32 is embedded into the receiving spaces of the hollow bodies 11 from the side opposite the open end 13 (i.e., the back side of the hollow body) to electrically connect with the mating connector. The connector 100 also includes multiple gaskets 4, which are detachably embedded in the rear end of the hollow bodies 11 of the housing units. Each gasket 4 has multiple openings 41, through which the opposite ends of the contacts in the upper contact group 31 and the lower contact group 32 pass to electrically connect to the external circuit board 200 after passing through the openings 41.

In summary, the connector of the present invention comprises a combination of a housing, identification units, contacts, and gaskets. Since the connector in the present invention aims to reduce width and volume thereof, the housing is designed with an integrated structure, where a single housing has multiple housing units. With this integrated design, the present invention effectively provides multiple identification units on the housing to distinguish the different connectors with different specifications on the same housing. Combined with different key structures on the housing units, it easily achieves proper connection of mating connectors. Additionally, the integrated structure design of the connector in the present invention also solves the assembly tolerance issues faced by traditional multi-piece connectors for thereby reducing subsequent production time and manufacturing costs.

The above embodiments are used only to illustrate the implementations of the present invention and to explain the technical features of the present invention, and are not used to limit the scope of the present invention. Any modifications or equivalent arrangements that can be easily accomplished by people skilled in the art are considered to fall within the scope of the present invention, and the scope of the present invention should be limited by the claims of the patent application.

What is claimed is:

1. A connector, comprising:
a housing, having a plurality of housing units, each of the housing units has a hollow body, a key structure and an open end, wherein the key structure is formed on an inner edge of the hollow body, the open end is formed on a side surface of the hollow body, the hollow body and the open end jointly define a receiving space for connecting a mating connector, the housing units are integrally formed with each other, and the key structures of the housing units are different from each other; and
a plurality of identification units, each of the identification units respectively disposed on each of the housing units to identify and distinguish each of the housing units correspondingly.

2. The connector of claim 1, wherein each of the identifications units is a color plate, and each of the color plates has a different color for identify and distinguish each of the housing units correspondingly.

3. The connector of claim 2, wherein each of the color plates is detachably embedded in each of the housing units.

4. The connector of claim 3, wherein each of the color plates has an embedding section, each of the hollow bodies of the housing units has an embedding groove, disposed on a top surface of each of the hollow bodies, and each of the embedding sections is detachably embedded in each of the embedding grooves so that each of the color plates is individually fixed in each of the housing units.

5. The connector of claim 1, wherein each of the identification units is a coloring section formed on an end surface of the open end of each of the hollow bodies, and each of the coloring sections has a different color to identify and distinguish each of the housing units correspondingly.

6. The connector of claim 1, further comprising a plurality of contacts, one end of each of the contacts is embedded in each of the receiving spaces from an opposite side of each of the open ends of the hollow bodies, for electrically being connected to contacts of the mating connector.

7. The connector of claim 6, wherein the contacts are divided into an upper contact group and a lower contact group, when the contacts are embedded in each of the receiving spaces, the lower contact group is positioned under the upper contact group.

8. The connector of claim 6, further comprising a plurality of gaskets, detachably embedded in each of the housing units, wherein each of the gaskets has a plurality of openings for the other opposite end of each of the contacts passing through the openings accordingly.

9. The connector of claim 8, wherein the housing is positioned on an external circuit board, and the other opposite end of each of the contacts is electrically connected to the external circuit board after passing through each of the openings.

10. The connector of claim 9, wherein the housing further comprises at least positioning pin, being disposed on a bottom side of the hollow bodies and passing through the external circuit board to position the housing on the external circuit board.
